(19) United States
(12) Patent Application Publication
(10) Pub. No.: US 2026/0014045 A1
(43) Pub. Date: Jan. 15, 2026

(54) SYSTEMS, METHODS, DEVICES, AND APPARATUSES FOR PROVIDING ASSISTANCE TO USERS

(71) Applicant: Hua Harry Li, Palo Alto, CA (US)

(72) Inventor: Hua Harry Li, Palo Alto, CA (US)

(21) Appl. No.: 19/331,847

(22) Filed: Sep. 17, 2025

Related U.S. Application Data
(63) Continuation-in-part of application No. 18/738,939, filed on Jun. 10, 2024.
(60) Provisional application No. 63/507,112, filed on Jun. 9, 2023.

(51) Int. Cl. A61H 3/04; A61H 3/00; B25J 5/00; B25J 9/16; B64U 70/90; B64U 101/31

(52) U.S. Cl. CPC A61H 3/04; B25J 5/007; B25J 9/1664; B64U 70/90; A61H 2003/004; A61H 2003/043; A61H 2003/046; A61H 2201/0161; A61H 2201/1207; A61H 2201/1635; A61H 2201/5058; A61H 2201/5084; B64U 2101/31

(57) ABSTRACT

The present disclosure provides an apparatus for providing assistance. Further, the apparatus may include a frame comprising two or more frame members interconnected to define a structure. Further, the apparatus may include a movement assembly configured for moving the apparatus for navigating the apparatus. Further, the apparatus may include a processor configured for determining one or more requirements of a user associated with the apparatus and generating one or more commands based on the one or more requirements. Further, the one or more commands includes one or more navigation commands and one or more operation commands for performing one or more tasks. Further, the moving of the apparatus may be based on the one or more navigation commands. Further, the apparatus may include a peripheral device configured for executing one or more operations for the performing of the one or more tasks based on the one or more operation commands.

### FIELD OF DISCLOSURE

The present disclosure relates to the field of mobility assistance technologies. More specifically, the present disclosure relates to systems, methods, devices, and apparatuses for providing assistance to users.

### BACKGROUND

The field of mobility assistance technologies encompasses devices and systems designed to support individuals with impaired mobility in navigating their environments safely and independently. The given field is of critical importance because mobility limitations may substantially diminish quality of life, restrict access to essential daily activities, and increase dependence on caregivers. With the growing proportion of elderly and mobility-impaired populations worldwide, advancements in the given field play a vital role in enabling individuals to live with dignity, autonomy, and enhanced safety.

A desirable objective in the given field is to provide comprehensive assistance that not only supports walking stability but also facilitates the execution of daily living tasks, such as navigating complex indoor environments, retrieving objects, and maintaining personal safety. Achieving the given objective requires solutions that extend beyond basic mechanical support and address the broader challenges faced by individuals who rely on mobility aids.

However, existing solutions often fall short of the given objective. Many current devices provide only limited mechanical stability without offering meaningful assistance in interacting with the environment. Users frequently encounter challenges when navigating cluttered or dynamic spaces where obstacles may shift unexpectedly. Retrieving forgotten or out-of-reach items may pose significant difficulties and may increase the risk of falls or injuries. Furthermore, existing solutions typically do not provide meaningful support for monitoring user well-being or adapting to varying environmental conditions, leaving individuals without assistance in situations that demand a quick or intelligent response. Communication between the user and the device is often limited to rudimentary controls, which may be unintuitive or inaccessible to those with physical or cognitive impairments. Additionally, secure handling of sensitive user-related data and the ability to adapt to changing user behaviors over time are generally not addressed by current systems.

Therefore, there is a need for improved systems, methods, devices, and apparatuses for providing assistance to users that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparatus for providing assistance to users. Further, the apparatus may include a frame comprising two or more frame members. Further, the two or more frame members may be interconnected to define a structure. Further, the apparatus may include a movement assembly coupled to the frame. Further, the movement assembly may be configured for moving the apparatus for navigating the apparatus. Further, the apparatus may include a processor communicatively coupled to the movement assembly. Further, the processor may be configured for determining one or more requirements of a user associated with the apparatus. Further, the processor may be configured for generating one or more commands based on the one or more requirements. Further, the one or more commands include one or more navigation commands for the navigating of the apparatus and one or more operation commands for performing one or more tasks. Further, the moving of the apparatus may be based on the one or more navigation commands. Further, the apparatus may include one or more peripheral devices communicatively coupled with the processor. Further, the one or more peripheral devices may be configured for executing one or more operations for the performing of the one or more tasks based on the one or more operation commands.

The present disclosure provides an apparatus for providing assistance to users. Further, the apparatus may include a frame comprising two or more frame members.

Further, the two or more frame members may be interconnected to define a structure. Further, the apparatus may include a movement assembly coupled to the frame. Further, the movement assembly may be configured for moving the apparatus for navigating the apparatus. Further, the apparatus may include a processor communicatively coupled to the movement assembly. Further, the processor may be configured for determining one or more requirements of a user associated with the apparatus. Further, the processor may be configured for generating one or more commands based on the one or more requirements. Further, the one or more commands include one or more navigation commands for the navigating of the apparatus and one or more operation commands for performing one or more tasks. Further, the moving of the apparatus may be based on the one or more navigation commands. Further, the apparatus may include one or more peripheral devices communicatively coupled with the processor. Further, the one or more peripheral devices may be configured for executing one or more operations for the performing of the one or more tasks based on the one or more operation commands. Further, the apparatus may include one or more sensors communicatively coupled with the processor. Further, the one or more sensors may be configured for monitoring an environment associated with the apparatus. Further, the processor may be further configured for generating one or more sensor data based on the monitoring. Further, the processor may be further configured for analyzing the one or more sensor data. Further, the generating of the one or more commands may be further based on the analyzing of the one or more sensor data.

The present disclosure provides an apparatus for providing assistance to users. Further, the apparatus may include a frame comprising two or more frame members. Further, the two or more frame members may be interconnected to define a structure. Further, the apparatus may include a movement assembly coupled to the frame. Further, the movement assembly may be configured for moving the apparatus for navigating the apparatus. Further, the apparatus may include a processor communicatively coupled to the movement assembly. Further, the processor may be configured for determining one or more requirements of a user associated with the apparatus. Further, the processor may be configured for generating one or more commands based on the one or more requirements. Further, the one or more commands include one or more navigation commands for the navigating of the apparatus and one or more operation commands for performing one or more tasks. Further, the moving of the apparatus may be based on the one or more navigation commands. Further, the apparatus may include one or more peripheral devices communicatively coupled with the processor. Further, the one or more peripheral devices may be configured for executing one or more operations for the performing of the one or more tasks based on the one or more operation commands. Further, the one or more peripheral devices includes one or more of one or more unmanned aerial vehicles (UAVs) and one or more bionic arms. Further, the one or more UAVs may be configured for executing one or more first unmanned aerial vehicle (UAV) operations. Further, the one or more bionic arms may be configured for executing one or more assistive operations. Further, the executing of the one or more operations by the one or more peripheral devices includes one or more of the executing of the one or more UAV operations by the one or more UAVs and the executing of the one or more assistive operations by the one or more bionic arms. Further, the apparatus may include one or more input devices communicatively coupled with the processor. Further, the one or more input devices may be configured for generating one or more user inputs. Further, the processor may be further configured for analyzing the one or more user inputs. Further, the generating of the one or more commands may be further based on the analyzing of the one or more user inputs.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a perspective view of an apparatus 100, in accordance with some embodiments.

FIG. 2A illustrates a perspective view of the apparatus 100 including one or more unmanned aerial vehicles (UAVs) 208, in accordance with some embodiments.

FIG. 2B illustrates a top perspective view of the apparatus 100 including one or more UAVs 208 and one or more bionic arms 218, in accordance with some embodiments.

FIG. 3 illustrates a block diagram of the apparatus 100, in accordance with some embodiments.

FIG. 4 illustrates a facial recognition and navigation workflow 400 associated with the apparatus 100, in accordance with some embodiments.

FIG. 5 illustrates a flowchart of a process 500 associated with one or more UAV operations, in accordance with some embodiments.

FIG. 6A illustrates a computer vision output (Raw RGB) associated with the one or more UAVs 208 detecting one or more objects, in accordance with some embodiments.

FIG. 6B illustrates a computer vision output (detection) associated with the one or more UAVs 208 detecting one or more objects, in accordance with some embodiments.

FIG. 7 illustrates a docking site associated with the one or more UAVs 208 on the one or more trays 206, in accordance with some embodiments.

FIG. 8 illustrates a use case scenario 800 associated with the one or more UAVs 208, in accordance with some embodiments.

FIG. 9 illustrates a perspective view of the one or more bionic arms 218, in accordance with some embodiments.

FIG. 10 illustrates a perspective view of the one or more bionic arms 218 including the one or more UAVs 208, docked on the one or more trays 206, in accordance with some embodiments.

FIG. 11 illustrates one or more operations associated with the one or more bionic arms 218, in accordance with some embodiments.

FIG. 12 illustrates a flowchart of a process 1200 associated with a user interface for one or more of a manual mode and an AI-assisted mode of the apparatus 100, in accordance with some embodiments.

FIG. 13 is an illustration of an online platform 1300 consistent with various embodiments of the present disclosure.

FIG. 14 is a block diagram of a computing device 1400 for implementing the methods disclosed herein, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure provides a novel rollator system, hereinafter referred to as “The Robolator,” comprising an AI-powered self-driving rollator platform, an onboard drone capable of object identification and environmental monitoring, and a robotic arm capable of performing pick-and-place tasks. Further, the given components work together under the control of a central processing unit, enabling automated assistance for daily living activities.

Further, the disclosed system relates to the field of mobility aids. More specifically, the disclosed system pertains to an intelligent rollator equipped with autonomous navigation, a flying drone assistant, and a bionic robotic arm to enhance the safety, independence, and convenience of elderly and mobility-impaired individuals.

Further, traditional rollators are manually operated and do not assist users beyond mechanical support. Many users, particularly the elderly, often face challenges such as retrieving forgotten items, monitoring household conditions, or manipulating everyday objects. With the advancement of artificial intelligence (AI), robotics, and computer vision, there is an opportunity to enhance the functionality of rollators through intelligent integration.

In some embodiments, the disclosed system may include the following components:
1. Rollator Frame and Drive System: The base of the disclosed system comprises a rollator frame with standard structural support, wheels, and braking systems. Further, the rollator frame includes a battery-powered electric drive mechanism allowing both remote control and autonomous movement.
2. Autonomous Navigation and Facial Recognition: A facial recognition module, utilizing a front-mounted camera and deep learning based neural inference hardware, is used to authenticate and locate the user. Navigation sensors such as LIDAR, depth cameras, and IMUs are employed for real-time path planning and obstacle avoidance.
3. Foldable Tray and Drone Platform: The foldable tray is designed and mounted on the rollator and serves a dual purpose: carrying items and providing a takeoff/landing pad for the onboard drone. The tray includes alignment guides and a charging system (contact-based or inductive).
4. Drone-Based Flying Assistant: The drone is a lightweight indoor UAV equipped with cameras, visual SLAM algorithms, and onboard and on-rollator-based central AI. Further, the control modes of the drone include manual joystick operation and AI-assisted automation for taking off and landing, and surveying the environment for object recognition. Further, the drone may autonomously perform tasks such as locating medicine bottles, keys, or mobile phones and verifying stove or appliance status. Further, the drone communicates wirelessly with the central AI unit and returns autonomously to its docking station.
5. Bionic Robotic Arm: The 6-degree-of-freedom (DoF) robotic arm is attached to the side or front of the rollator. Further, the bionic robot arm includes multiple joints and an end effector capable of grasping common objects. Further, the control modes include manual joystick operation and AI-assisted automation for tasks such as lifting and placing objects on the tray.
6. Central AI Control Unit: An embedded processor is attached to the robolator (i.e., rollator); the processor coordinates the operation of the rollator, drone, and robotic arm. Further, the processor processes sensor data, executes pathfinding algorithms, manages user authentication, and interprets object recognition from the drone and cameras.

In some embodiments, the present disclosure may describe an intelligent mobility assistance system that may include:
a rollator frame;
a battery-powered drive system configured for remote and autonomous control;
a facial recognition module configured to detect and authenticate a user;
a foldable tray mounted to the rollator frame;
an autonomous drone configured to take off from and land on the tray, equipped with computer vision and navigation capabilities;
a robotic arm attached to the rollator, operable in both manual and AI-assisted modes for pick-and-place tasks.

Further, the intelligent mobility assistance system may include obstacle detection sensors and path planning capabilities. Further, the drone is capable of locating specified household items and performing environmental checks. Further, the robotic arm may include at least five degrees of freedom and a gripper for object manipulation. Further, the intelligent mobility assistance system may include a central AI controller for coordinating the rollator, drone, and robotic arm. Further, the tray may include embedded charging contacts or inductive coils for drone recharging.

Further, in some embodiments, the robolator represents a comprehensive enhancement of mobility aids, leveraging AI and robotics to support users in complex indoor environments. The disclosed system not only assists with walking but also extends to object handling and environmental interaction, significantly improving autonomy and safety for the elderly and disabled.

Further, the disclosed system is a battery-powered, remote-controllable rollator comprising a rollator, a plurality of motorized wheels, a plurality of swivel wheels, a plurality of mechanical hand brakes, an emergency battery power switch, a front color camera, a rear color camera, a battery, and an instrument panel housing a control module further comprising a plurality of sensors including a magnetometer, an acceleration sensor, an impact detection sensor, and a plurality of proximity sensors.

Further, the control module of the rollator. The term “module” or the term “controller” may be replaced with the term “electronics circuit” or “software program.” The term “module” may refer to, be part of, or include microprocessor hardware that executes the software program or memory hardware participating in the microprocessor processing and storing code executed by an embedded computer. The software program is written to provide each module functionality as well as the integrated functionality of the control module. The control module is housed within the instrument panel. The control module further comprises an embedded computer which has real time operating systems, executes programs to realize artificial intelligence functions, such as path planning, facial recognition, and motor control for the self-driving of the rollator. For example, the user may use his/her smartphone application to communicate with the control module via WiFi module or Bluetooth module to drive the rollator or use the color camera module to capture the user's face. The computer vision module performs feature extraction tasks to build high-dimensional feature vectors to feed feature vectors to the deep learning module for further processing and feature classification, in addition to online learning and adaptation for better feature classification. The feature vectors of the processed image are fed into the facial recognition module for facial recognition. To enhance the quality of the feature vector extraction and deep learning function, the computer vision module conducts image pre-processing such as image enhancement, color balancing, and segmentation, contour analysis, and topological and geometric features processing. As a result, the user's facial signature is positively identified by the facial recognition module. The control module further comprises a smartphone interface module, which consists of the communication protocols, software processing unit, and the user interface system.

If the user requests self-driving via smartphone by using a smartphone application, the request is received by the WiFi module, then parsed and processed by a web server. The embedded computer module communicates with the path planning module, where navigation parameters are computed before a set of motion commands is generated and sent back to the embedded computer. The embedded computer communicates with the customized IO module, which is configured to customize settings of the communication protocols, such as Modbus, to the motor controller module to drive the motorized wheels to reach the user. The stopping criteria are determined by the software program of the customized IO module. Once the stopping criteria are satisfied, a stop command is issued to halt the motorized wheels.

In some embodiments, the user may use his/her smartphone to choose the smartphone application of the user interface system to execute a remote control function. The main page of the user interface system, whose implementation comprises at least five selection buttons for the selection of user interface functions. Further, the buttons relate to: main page; drive page for executing driving commands; MyFacial page to take a facial photo and upload the photo; setting page to configure Bluetooth, to configure Wi-Fi, and to connect to WiFi wireless communication; and help page to provide instructions for troubleshooting. To operate the remote control or self-driving function of the rollator, a user starts from the main page; configures the Bluetooth wireless communications with the page, and WiFi wireless communications with, and activates the configured WiFi connection. Once wireless settings are configured, the user navigates to my facial page, takes a facial photo of himself or herself or selects an existing facial photo, then uploads the photo. Successfully uploading an acceptable photo completes the user registration of the rollator, enabling facial recognition using the chosen facial photo. Once facial recognition is enabled, the user may navigate to the drive page to select driving commands, such as forward, backward, left, right, or self-driving. The user may navigate to the help page to get information if they have any questions.

Further, the present disclosure describes an operation procedure according to an embodiment of the disclosed system. The procedure begins by powering up the rollator, then activating the smartphone program for an iPhone or an Android phone. Once the application program starts, the user navigates to the main menu, configures Bluetooth and WiFi, and activates the WiFi network. Next, the user navigates to my facial page, takes a face photo of himself/herself or selects an existing facial photo, and clicks the button on the page to upload the photo. The given process completes user registration. For remote-controlled driving, the user navigates to the drive page to select driving commands or self-driving.

Further, the rollator comprises a structure and a plurality of handles for the user to hold onto. Further, the plurality of mechanical hand brakes is attached onto the structure from the motorized wheels up to the top of the structure, where a user may actuate the brake function. Further, a mechanical hand brake is present for each motorized wheel. Further, the rollator is designed to be light and portable. In some embodiments, the rollator is designed to have foldable components and may be collapsed for storage.

Further, the plurality of motorized wheels accelerates the disclosed system into motion. Further, two motorized wheels are connected to the bottom of the rollator. Further, the motorized wheels are brushless direct current (BLDC) hub motors. Further, the plurality of swivel wheels allows the disclosed system to turn and rotate. Further, two swivel wheels are connected to the bottom of the rollator.

In some embodiments of the disclosed system, the battery is a rechargeable lithium-ion battery. The battery is sealed, maintenance-free, and has over a thousand recharge cycles. Further, the battery may include emergency battery safety features to prevent combustion or explosion in case of impact or damage. Further, the battery is connected to the emergency battery power switch, which is attached to the structure of the rollator. Further, the emergency battery power switch may be activated to shut off the battery in case of an emergency.

Further, the embedded computer comprises a wireless communication system, a computer vision system, and an artificial intelligence algorithm. Further, the computer vision system recognizes the user's face by processing each image frame from the video, then utilizes artificial intelligence technology, namely, the deep convolutional neural networks, to perform user identity recognition. Once the identity of the user is derived from the computation, a region of interest (ROI) is defined with its center location and the shape parameters, including width and height. The identity information, location, and shape parameters are utilized by the artificial intelligence algorithm to compute the motion path for the rollator. The motion path is fed to an embedded multi-channel motor controller, one for each motorized wheel. Based on the computed path, the embedded computer actuates the motorized wheels to reposition the rollator to travel in the optimal path moving towards the user. As the motion takes place, the continued computation of the user identity and its distance to the rollator are updated. Once the distance reaches a predefined stopping distance, the artificial intelligence algorithm may stop the motor actuation and rollator motion. Further, the wireless communication system may be controlled by a smartphone application or a remote controller. The user may configure the disclosed system to self-drive for the user, remotely control the rollator, and access the cameras on the rollator to receive a real-time video stream. For example, a user may remotely control the disclosed system and use its cameras to view into other rooms or locations. Further, the artificial intelligence algorithm may include facial recognition, gesture recognition through analyzing data from the cameras and sensors. The artificial intelligence algorithm is formed from commercially available API data with proprietary data, and training guidelines.

Further, the front color camera is a front-facing camera that records environmental information ahead of the rollator. Further, the rear color camera is a rear-facing camera that records environmental information behind the rollator. The environmental information is fed to the computer vision system. Such information includes identity information used for facial recognition.

In some embodiments, the magnetometer, the acceleration sensor, and the impact detection sensor are found in a single combination sensor. The combination sensor is commonly used within airplanes and drones. The magnetometer provides compass-like information to the embedded computer. The acceleration sensor provides orientation information, location information, and acceleration information to the embedded computer. The impact detection sensor records any information related to collisions and the impact of the rollator and provides information to the embedded computer. The location information recorded by the combination sensor may be more reliable when used indoors, as common GPS location data may not be as reliable, accurate, or precise. The combination sensor allows the disclosed system to record data that may be medically beneficial for the user. For example, the combination sensor is sensitive enough to record data of the user's gait. The given data may be analyzed by a user's physician to provide instructions for the user to prevent falls and injury. The data is saved locally on the embedded computer itself and may be uploaded to a private cloud server through its wireless communication. The data may then be privacy-locked and controlled entirely by the user through a smartphone application. The smartphone application comprises a graphical user interface that remotely interacts with the embedded computer to control the rollator and adjust other settings for use, such as facial recognition.

In some embodiments, the plurality of proximity sensors comprises at least four proximity sensors. The proximity sensors are located above the motorized wheels and the swivel wheels and oriented to face the rollator's front, back, left, and right sides. Further, each proximity sensor may view and record data with beyond 120-degree field of view for each sensor, covering all 360 degrees around the rollator with overlapped regions. The data is characterized as a semantic description of the environment around the disclosed system. The proximity sensors utilize environment data together with computer vision to form an environment awareness capability to enable autonomous driving with limited functions.

In some embodiments, the present disclosure describes a battery powered, motorized rollator comprising a rollator, a plurality of motorized wheels, a plurality of swivel wheels, a plurality of mechanical hand brakes, a front color camera, a rear color camera, a rechargeable battery, an emergency battery power switch, an instrument panel, a control module, an embedded computer, a plurality of software program modules, a magnetometer, an acceleration sensor, an impact detection sensor, and a plurality of proximity sensors. Further, the front color camera, the rear color camera, the magnetometer, the acceleration sensor, the impact detection sensor, and the plurality of proximity sensors record and provide data to the embedded computer to enable self-driving by controlling the plurality of motorized wheels.

Further, the plurality of software program modules may include a WiFi module, a Bluetooth module, a color camera module, a video streaming module, a computer vision module, a deep learning module, a facial recognition module, a smartphone interface module, a proximity sensor module, a motion monitoring module, a manual driving module, an acceleration sensor module, a path planning module, a customized IO module, and a motor controller module. Further, the embedded computer executes the plurality of software program modules to realize an artificial intelligence function including one or more of a path planning, a facial recognition, and a motor control of the rollator.

Further, the rollator is foldable. Further, the plurality of motorized wheels are brushless direct current hub motors. Further, the battery may include emergency battery safety features to prevent combustion or explosion in case of impact or damage.

Further, the battery-powered, motorized rollator may include a smartphone application. Further, the smartphone application may remotely control the embedded computer to manually drive the rollator.

Further, the battery-powered, motorized rollator may include a remote controller. Further, the remote controller may remotely control the embedded computer to manually drive the rollator.

Further, the plurality of proximity sensors may view and record a 360-degree field of view together with computer vision to form a 3D environment awareness capability for collision avoidance.

In some embodiments, the present disclosure may describe the battery-powered, remote-controllable rollator with embedded computer systems and the computer vision system. Further, the battery-powered, remote-controllable rollator recognizes the user's face by using artificial intelligence technology, namely, the deep convolutional neural networks, and uses that information to localize the rollator's position in relation to the user. Further, an artificial intelligence algorithm computes the motion path and drives the battery-powered, remote-controllable rollator to the user. Further, the battery-powered, remote-controllable rollator may automatically stop once approached to a preset stopping distance from the user. Once stationary, the battery-powered, remote-controllable rollator may then be used by the user.

In some embodiments, the disclosed system may provide a rollator system integrated with autonomous navigation using advanced simultaneous localization and mapping (SLAM) techniques. The technical problem addressed here is that traditional mobility aids cannot safely and autonomously navigate complex and dynamic indoor environments with moving obstacles such as pets or other humans. The improvement lies in deploying real-time visual-inertial odometry combined with deep neural network-based scene understanding. For example, the rollator system may utilize multi-camera arrays combined with LIDAR and fused IMU readings to dynamically generate semantic occupancy maps that classify obstacles as static or dynamic. In some embodiments, the rollator may improve upon conventional assistive navigation by incorporating predictive trajectory modeling of moving obstacles, thereby avoiding collisions before they occur, improving the technology of autonomous robotic navigation for indoor assistive devices.

In some embodiments, the disclosed system may provide facial recognition for user authentication and localization. The technical problem solved here is ensuring secure and personalized interaction with the rollator system in multi-user environments (such as care homes). The disclosed system may implement lightweight convolutional neural networks optimized for edge hardware to detect and verify the user in real time, thus eliminating the need for manual login or wearable devices. In some embodiments, the disclosed system may store encrypted biometric templates and periodically retrain on updated facial data to maintain accuracy under changing conditions such as lighting, aging, or occlusions like glasses. The technology improved is biometric authentication for edge-AI mobility platforms.

In some embodiments, the disclosed system may integrate a foldable tray that doubles as a drone platform. The technical problem addressed is the lack of multipurpose structural integration in conventional rollators. By embedding alignment guides, inductive charging coils, and haptic feedback indicators, the tray may serve both as a stable surface for user items and as a drone docking station. In some embodiments, wireless charging pads may be placed at multiple points to ensure reliable charging regardless of imperfect drone landing alignment, improving drone docking and wireless charging infrastructure for mobile assistive systems.

In some embodiments, the drone assistant may be configured with onboard vision-based deep learning for object recognition and status monitoring of household appliances. The problem solved is the difficulty elderly or mobility-impaired users face in locating small or scattered objects or verifying whether appliances (e.g., stove burners) have been left on. The drone may use transfer-learned object detectors fine-tuned for household objects. In some embodiments, the drone may be trained to interpret visual cues of safety hazards, such as smoke or overflowing containers, and alert the user or caregivers, improving indoor drone perception and autonomous task execution for assistive living.

In some embodiments, the bionic robotic arm may provide six degrees of freedom with AI-assisted grasp planning. The technical problem solved is the inability of conventional robotic aids to reliably grasp varied objects with different shapes, textures, and fragility. The arm may implement deep reinforcement learning for adaptive grasp control and tactile sensing to prevent slippage or over-force application. For example, the arm may grasp a fragile glass of water using low-force precision pinch or may lift a heavy grocery bag using a power grasp. In some embodiments, interchangeable end effectors may be included, such as suction grippers or soft robotics fingers, to extend functional versatility, improving robotic manipulation for domestic assistive technology.

In some embodiments, the disclosed system may integrate a central AI controller that coordinates data from navigation sensors, drone perception, and robotic arm control. The technical problem solved is fragmented decision-making when multiple subsystems operate independently, leading to delays or conflicting actions. The improvement lies in implementing multi-agent reinforcement learning where the rollator, drone, and arm act as cooperative agents sharing state vectors. In some embodiments, the central AI may use federated learning to update shared policies without raw data exchange, preserving privacy, improving multi-agent AI coordination in heterogeneous assistive robotics platforms.

In some embodiments, the disclosed system may include real-time physiological monitoring sensors (e.g., heart rate, oxygen saturation, or gait stability sensors) integrated into the rollator handles. The problem solved is the lack of continuous, passive health monitoring in conventional mobility aids. Implementation may involve embedding photo-plethysmography sensors into grips, inertial sensors into the handle frame, and wireless medical telemetry to caregivers, improving wearable-free health monitoring in mobile assistive devices.

In some embodiments, the rollator may include adaptive environment lighting controlled by the AI system. The problem solved is poor visibility for elderly users navigating low-light conditions. The rollator frame may include directionally adaptive LED lighting controlled by environmental brightness sensors and user gaze detection. For example, the disclosed system may brighten the path ahead while dimming unnecessary zones to reduce glare, improving context-aware illumination systems for assistive navigation.

In some embodiments, the disclosed system may include voice-interactive multimodal control enhanced with natural language processing. The problem solved is the steep learning curve of traditional remote controls or joysticks. The disclosed system may employ speech-to-intent recognition combined with visual confirmation, e.g., a user saying “Bring me my glasses,” while pointing in a general direction. The AI may fuse gesture recognition and voice commands for robust interpretation, improving human-AI interaction for assistive robotics.

In some embodiments, the disclosed system may integrate blockchain-based data logging for medical and operational events. The problem solved is the lack of a secure, verifiable history of rollator usage, patient interactions, and emergency alerts. Each event, such as a fall detection or medicine retrieval, may be immutably recorded on a distributed ledger accessible to healthcare providers, improving secure medical IoT data management.

In some embodiments, the disclosed system may include cloud-edge hybrid learning for personalization. The technical problem addressed is the limited computing power of edge devices that hinders continuous model retraining for evolving user behaviors. The rollator may perform lightweight inference and upload abstracted model weights to a secure cloud for federated aggregation, then receive updated optimized models. For example, navigation preferences (e.g., avoiding cluttered routes) may be continuously refined, improving adaptive AI personalization in edge-deployed assistive robotics.

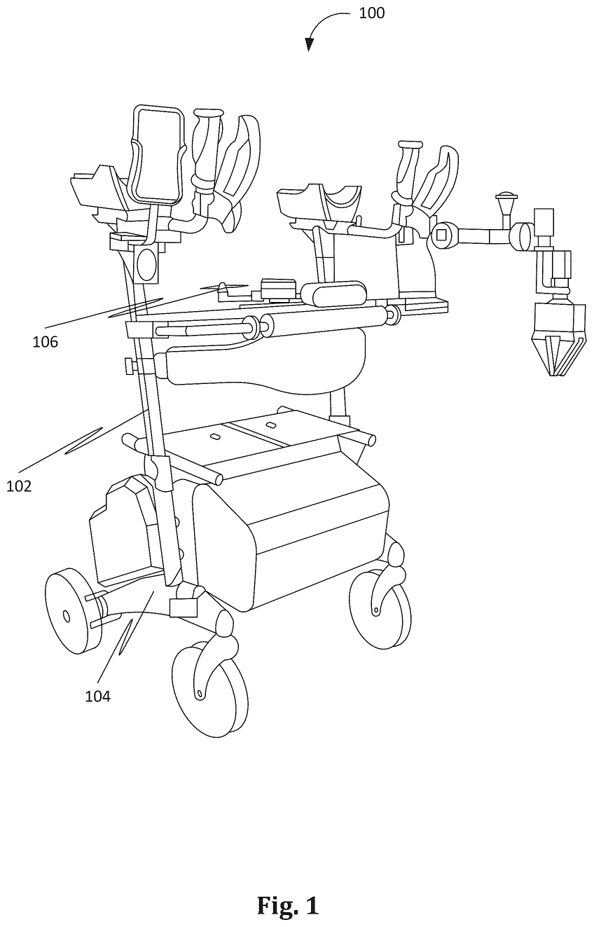

FIG. 1 illustrates a perspective view of an apparatus 100, in accordance with some embodiments.

Further, the apparatus 100 may include an intelligent rollator, a robolator, a smart rollator, etc. Further, the intelligent rollator may include one or more of a motor, a battery compartment, a foldable tray, a joystick controller 332, a smartphone on a phone holder, a pair of a pair of upper arm rest for the user, a carbon fiber frame, a color/depth camera and Lidar module, a bionic robot arm, a color camera on the bionic robot arm, an embedded system compartment hosting a central embedded AI processor, a drone, and a flying assistant.

Further, the apparatus 100 may include a frame 102 comprising two or more frame members. Further, the two or more frame members may be interconnected to define a structure. Further, the apparatus 100 may include a movement assembly 104 coupled to the frame 102. Further, the movement assembly 104 may be configured for moving the apparatus 100 for navigating the apparatus 100. Further, the moving may include performing a movement, a motion, etc. Further, the movement assembly 104 may include a plurality of motorized wheels, a plurality of swivel wheels, and a plurality of mechanical hand brakes. Further, the apparatus 100 may include a processor communicatively coupled to the movement assembly 104. Further, the processor may be configured for determining one or more requirements of a user 802 associated with the apparatus 100. Further, the processor may be configured for generating one or more commands based on the one or more requirements. Further, the one or more commands include one or more navigation commands for the navigating of the apparatus 100 and one or more operation commands for performing one or more tasks. Further, the moving of the apparatus 100 may be based on the one or more navigation commands. Further, the apparatus 100 may include one or more peripheral devices 106 communicatively coupled with the processor. Further, the one or more peripheral devices 106 may be configured for executing one or more operations for the performing of the one or more tasks based on the one or more operation commands. Further, the processor may include a Central AI Control Unit, an embedded central AI processor, a microprocessor, etc.

In some embodiments, the apparatus 100 further includes one or more sensors 202 communicatively coupled with the processor. Further, in some embodiments, the one or more sensors 202 may be configured for monitoring an environment associated with the apparatus 100. Further, the processor may be further configured for generating one or more sensor data based on the monitoring. Further, the processor may be further configured for analyzing the one or more sensor data. Further, the generating of the one or more commands may be further based on the analyzing of the one or more sensor data.

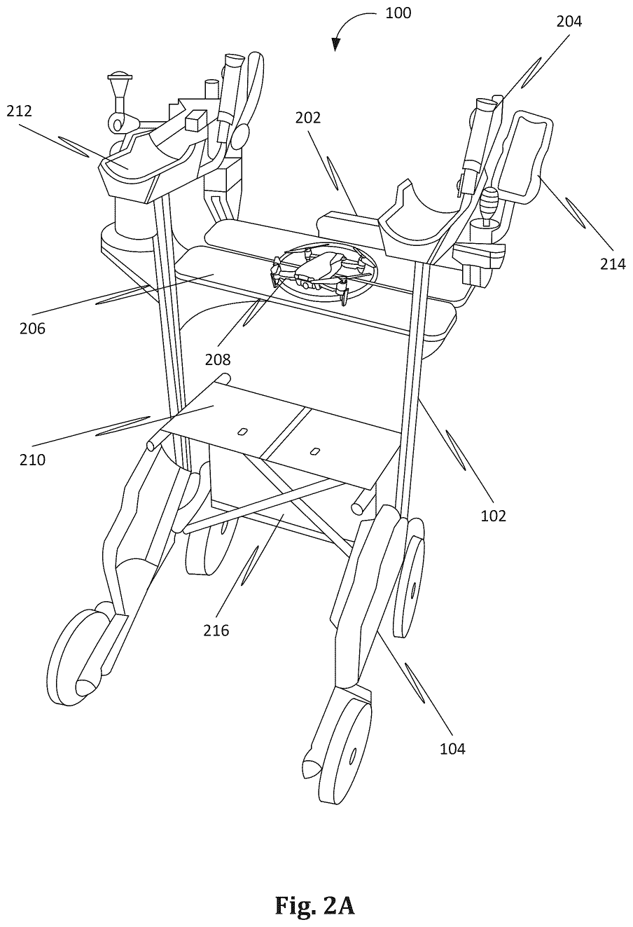

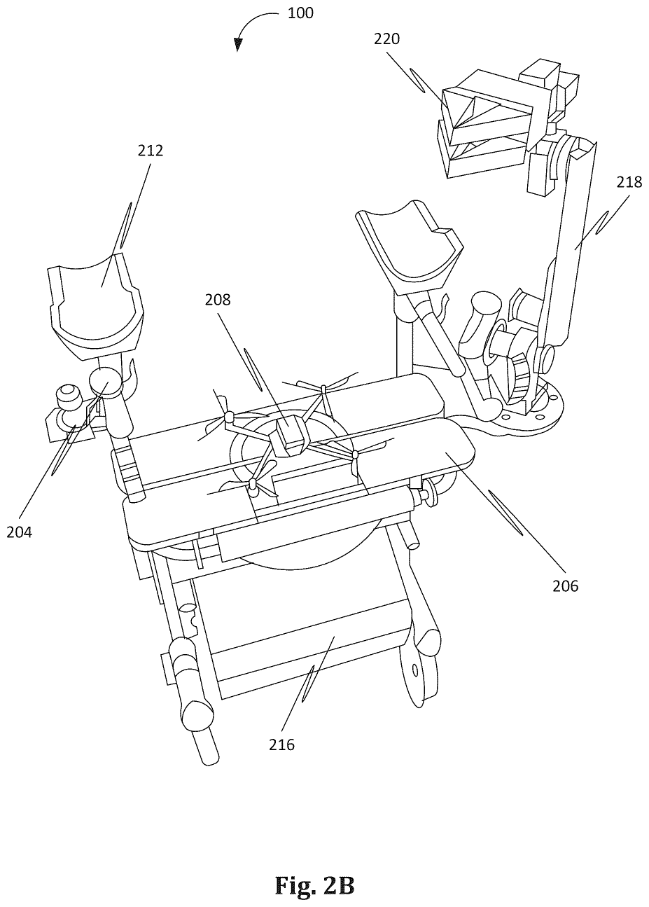

FIG. 2A illustrates a perspective view of the apparatus 100 including one or more unmanned aerial vehicles (UAVs), in accordance with some embodiments.

FIG. 2B illustrates a top perspective view of the apparatus 100 including one or more UAVs 208 and one or more bionic arms 218, in accordance with some embodiments.

In some embodiments, the apparatus 100 may further include one or more handles 204 coupled to the frame 102. Further, the one or more handles 204 may be configured to be held by the user 802.

In some embodiments, the apparatus 100 may further include one or more trays 206 mechanically coupled with the frame 102. Further, the apparatus 100 may be configured to transport one or more objects associated with the user 802 using the one or more trays 206 during the moving of the apparatus 100.

In some embodiments, the one or more peripheral devices 106 include one or more unmanned aerial vehicles (UAVs). Further, the one or more UAVs 208 may be configured for executing one or more first unmanned aerial vehicle (UAV) operations. Further, the executing of the one or more operations by the one or more peripheral devices 106 includes the executing of the one or more first UAV operations by the one or more UAVs 208.

In some embodiments, the one or more trays 206 may be foldable. Further, the one or more UAVs 208 may be configured to land on the one or more trays 206 and take off from the one or more trays 206.

In some embodiments, the one or more peripheral devices 106 include one or more bionic arms 218 operatively coupled with the frame 102. Further, the one or more bionic arms 218 may be configured for executing one or more assistive operations. Further, the executing of the one or more operations by the one or more peripheral devices 106 includes the executing of the one or more assistive operations by the one or more bionic arms 218. Further, the one or more assistive operations include one or more of an object-manipulation operation and an object-retrieval operation associated with one or more external objects present in the environment.

In some embodiments, the movement assembly 104 includes two or more wheels rotatably coupled with the frame 102. Further, the moving of the apparatus 100 may use the two or more wheels. Further, the movement assembly 104 further includes a braking assembly operatively coupled with the two or more wheels. Further, the braking assembly may be configured for restricting the motion of the apparatus 100. Further, the one or more navigation commands include one or more braking commands. Further, the restricting of the motion of the apparatus 100 may be based on the one or more braking commands.

In some embodiments, the one or more sensors 202 include one or more cameras. Further, the monitoring of the environment includes one or more of a capturing of one or more users within the environment and the capturing of the one or more external objects present in the environment.

In some embodiments, the one or more sensors 202 further include one or more navigation sensors. Further, the one or more navigation sensors may be configured for detecting one or more parameters associated with the moving of the apparatus 100. Further, the generating of the one or more sensor data may be further based on the detecting of the one or more parameters.

In some embodiments, the apparatus 100 may further include one or more input devices communicatively coupled with the processor. Further, the one or more input devices may be configured for generating one or more user inputs. Further, the processor may be further configured for analyzing the one or more user inputs. Further, the generating of the one or more commands may be further based on the analyzing of the one or more user inputs.

In some embodiments, the one or more first UAV operations include one or more of a landing operation, a flight operation, and a stationing operation. Further, the executing of the one or more first UAV operations by the one or more UAVs 208 includes one or more of the executing of the landing operation by the one or more UAVs 208, the executing of the flight operation by the one or more UAVs 208, and the executing of the stationing operation by the one or more UAVs 208. Further, the one or more trays 206 include one or more of an alignment guide 702 and a charging interface. Further, the alignment guide 702 may be configured for aligning the one or more UAVs 208 on one or more positions of the one or more trays 206 during the executing of the landing operation. Further, the charging interface may be configured for electrically charging the one or more UAVs 208 during the executing of the stationing operation.

In some embodiments, the one or more UAVs 208 include one or more UAV cameras. Further, the one or more first UAV operations further include a surveillance operation. Further, the executing of the one or more first UAV operations by the one or more UAVs 208 further includes the executing of the surveillance operation by the one or more UAVs 208 using the one or more UAV cameras during the executing of the flight operation.

In some embodiments, the one or more UAVs 208 further include a UAV processor communicatively coupled with each of the one or more UAV cameras and the processor. Further, the UAV processor may be configured for generating one or more surveillance data based on the executing of the surveillance operation. Further, the processor may be further configured for analyzing the one or more surveillance data. Further, the generating of the one or more commands may be further based on the analyzing of the one or more surveillance data.

In some embodiments, the processor may be further configured for generating one or more flight commands associated with the one or more UAVs 208 based on the analyzing of the one or more surveillance data. Further, the one or more UAVs 208 may be configured for executing one or more second unmanned aerial vehicle (UAV) operations.

Further, the executing of the one or more operations by the one or more peripheral devices 106 further includes the executing of one or more second UAV operations by the one or more UAVs 208. Further, the executing of the one or more second UAV operations may be based on the one or more flight commands. Further, the executing of the one or more second UAV operations occurs later than the executing of the one or more first UAV operations.

In some embodiments, the apparatus 100 may further include one or more battery units electrically coupled with the movement assembly 104. Further, the one or more battery units may be configured for powering the movement assembly 104. Further, the moving of the apparatus 100 may be further based on the powering of the movement assembly 104.

In some embodiments, the analyzing of the one or more user inputs includes the analyzing of the one or more user inputs using an artificial intelligence (AI) model. Further, the determining of the one or more requirements of the user 802 includes the determining of the one or more requirements of the user 802 using the AI model based on the analyzing of the one or more user inputs using the AI model. Further, the generating of the one or more commands may be further based on the determining the one or more requirements of the user 802 using the AI model.

In some embodiments, the processor may be further configured for identifying a location of the one or more external objects in the environment based on the analyzing the one or more surveillance data. Further, the generating of the one or more flight commands may be further based on the identifying of the location.

In some embodiments, the movement assembly 104 includes a drive assembly (i.e., a drive train, a power train, a motor, etc.) which may be configured to be operatively coupled with the two or more wheels. Further, the drive system may be further configured for generating a rotational torque. Further, the moving of the apparatus 100 may be further based on the rotational torque.

In some embodiments, the one or more navigation sensors include one or more of one or more LIDAR sensors, one or more depth-cameras, and one or more inertial measurement unit (IMU) sensors.

In some embodiments, the one or more parameters include one or more of a distance and an orientation of the one or more external objects.

In some embodiments, the one or more user inputs include one or more flight-based user inputs. Further, the analyzing of the one or more user inputs includes the analyzing of the one or more flight-based user inputs. Further, the generating of the one or more flight commands may be further based on the analyzing of the one or more flight-based user inputs.

In some embodiments, the object-manipulation operation includes a pick-and-place operation.

Further, in some embodiments, the generating of the one or more sensor data based on the monitoring of the environment may include generating one or more user facial image data based on the capturing of the one or more users. Further, the processor may be further configured for analyzing the one or more user facial image data. Further, the processor may be further configured for authenticating the one or more user facial image data based on the analyzing of the one or more user facial image data. Further, the determining of the one or more requirements may be further based on the authenticating of the one or more user facial images.

In some embodiments, the one or more external objects include one or more of one or more medicine bottles, one or more keys, and one or more mobile phones.

In some embodiments, the operative coupling of the one or more bionic arms 218 with the frame 102 includes operative coupling of the one or more bionic arms 218 in one or more attachment sections of the frame 102. Further, the one or more attachment sections include one or more of a front section and a lateral section of the frame 102.

In some embodiments, the one or more bionic arms 218 include a six-degree-of-freedom robotic arm.

In some embodiments, the one or more input devices include one or more joystick controllers 332 and one or more microphones.

In some embodiments, the one or more sensors 202 include an obstacle detection sensor.

In some embodiments, the one or more user inputs associated with the one or more microphones include one or more voice inputs associated with the user 802.

In some embodiments, the one or more bionic arms 218 include a gripper 220 which may be configured for facilitating the one or more assistive operations.

In some embodiments, the one or more input devices further include a smartphone associated with the user 802. Further, the apparatus 100 further includes a smartphone holder 214 mechanically coupled with the frame 102. Further, the smartphone holder 214 may be configured for securing the smartphone.

In some embodiments, the frame 102 includes a carbon fiber-based frame.

In some embodiments, the apparatus 100 may further include one or more arm rests 212 mechanically coupled with the frame 102. Further, the one or more arm rests 212 may be configured to facilitate resting of an arm of the user 802 during the holding of the one or more handles 204 by the user 802.

In some embodiments, the navigation of the apparatus 100 includes one or more of autonomous navigation of the apparatus 100 and manual navigation of the apparatus 100. Further, the manual navigation of the apparatus 100 may be further in response to a manual force from the user 802 applied to the apparatus 100.

In some embodiments, the two or more wheels may include one or more of one or more fixed wheels and one or more swivel wheels.

In some embodiments, the apparatus 100 may further include one or more storage modules 216 coupled with the frame 102. Further, the one or more storage modules 216 may be configured for storing the one or more objects associated with the user 802 during the moving of the apparatus 100.

In some embodiments, the electrical charging includes one or more of a contact-based charging and an inductive charging.

In some embodiments, the apparatus 100 may further include a seating assembly 210 mechanically coupled with the frame 102. Further, the seating assembly 210 may be configured to assist the user 802 in taking a rest.

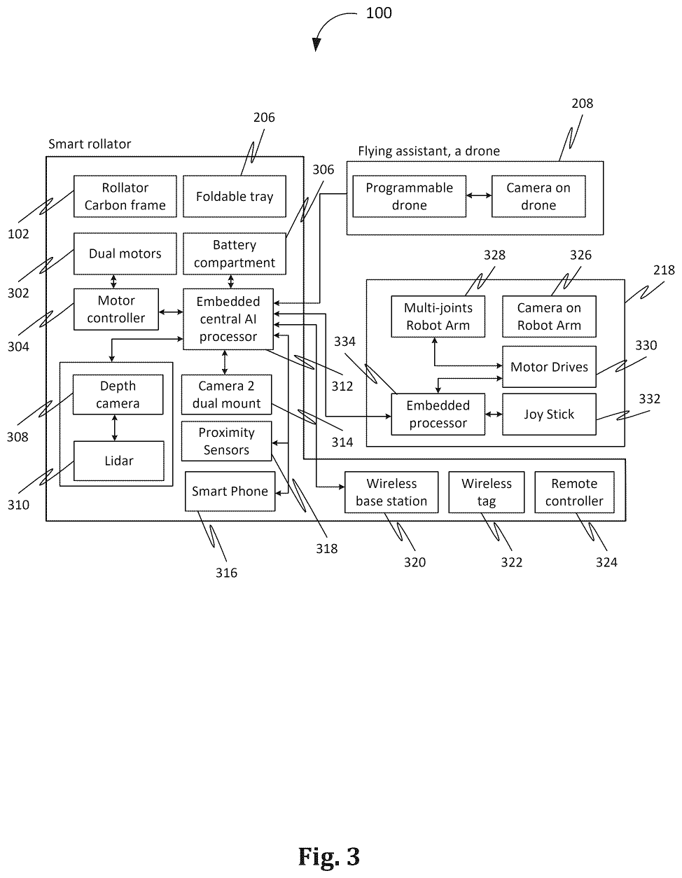

FIG. 3 illustrates a block diagram of the apparatus 100, in accordance with some embodiments.

Further, the apparatus 100 may include a dual motor unit 302, a motor controller 304, the battery compartment 306, the foldable tray 206, a carbon fiber frame 102, the embedded central AI processor 312, a depth camera 308, a camera 314, a Lidar unit 310, a proximity sensor unit 318 which may include two or more proximity sensors, a smart phone 316 as one of the human machine interface unit (HMI), a wireless base station 320 for user following functions, a wireless tag 322 to match up with the wireless base station 320, the remote controller 324.

Further, the one or more bionic arms 218 may include one or more of a camera 326, a multi-joint robot arm 328, one or more motor drives 330, and an embedded processor 334.

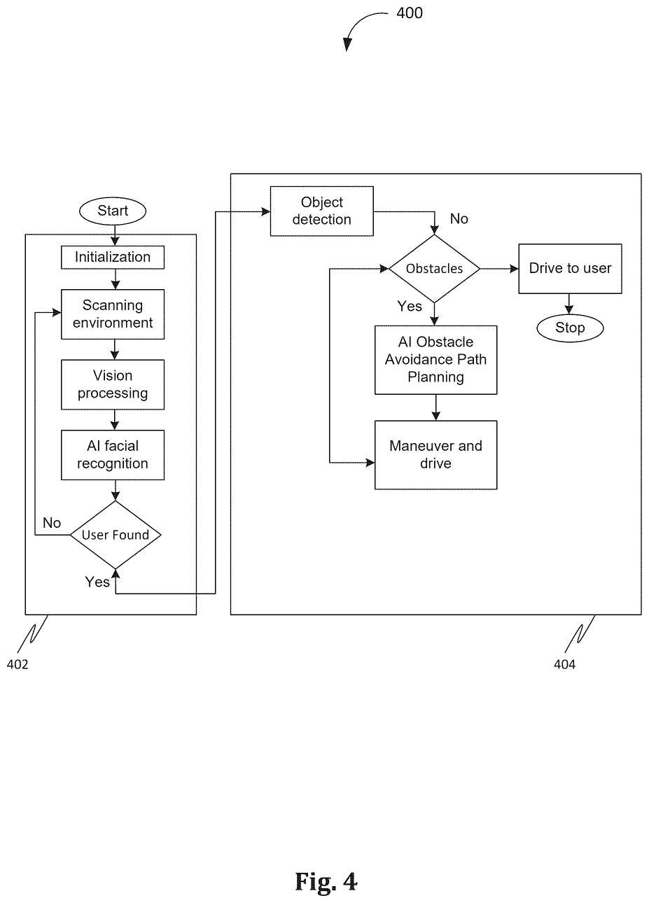

FIG. 4 illustrates a facial recognition and navigation workflow 400 associated with the apparatus 100, in accordance with some embodiments.

Further, the facial recognition and navigation workflow 400 may include a sequence 402 of AI facial recognition of the user 802 and a sequence 404 of AI path planning for one or more of obstacle avoidance and maneuver of the apparatus 100 to the user 802.

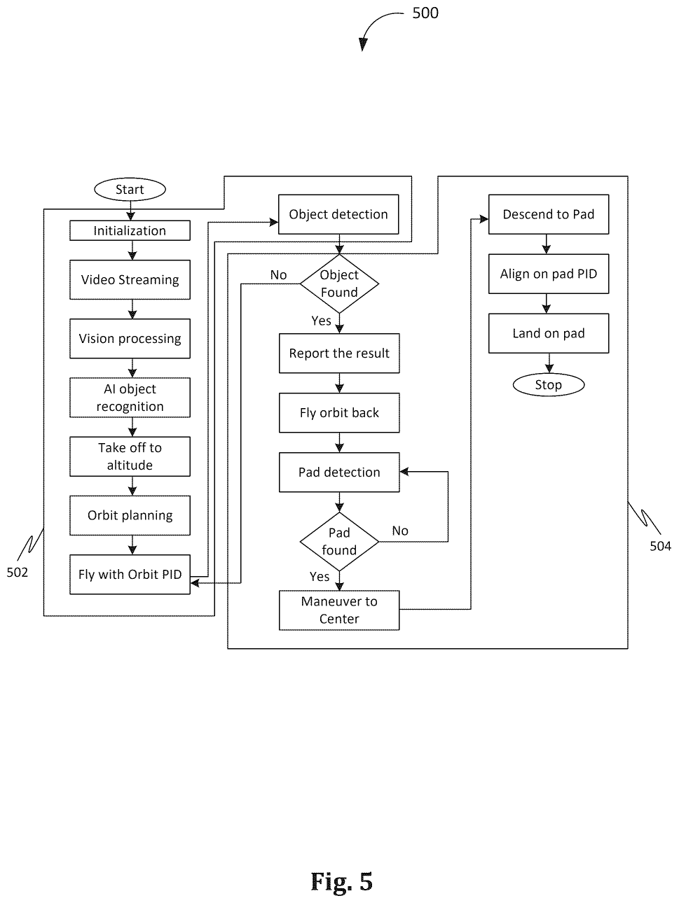

FIG. 5 illustrates a flowchart of a process 500 associated with one or more UAV operations, in accordance with some embodiments.

Further, the process 500 may include a sequence 502 of object detection. Further, the process 500 may include a sequence 504 of flying back and landing on a pad. Further, in order to have precision control of the maneuver, PID (proportional, integral, and derivative control) and other intelligent control techniques are applied.

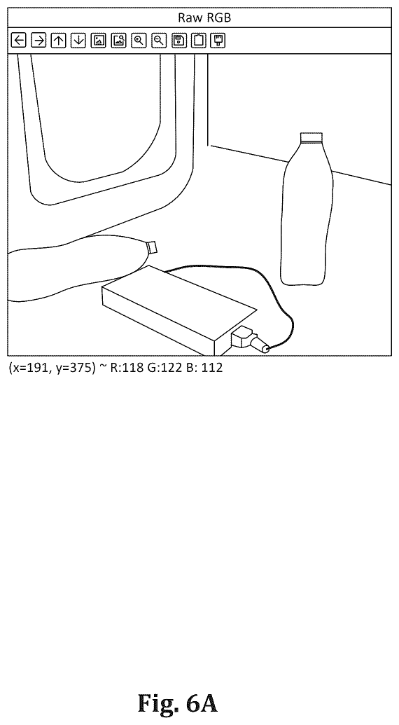

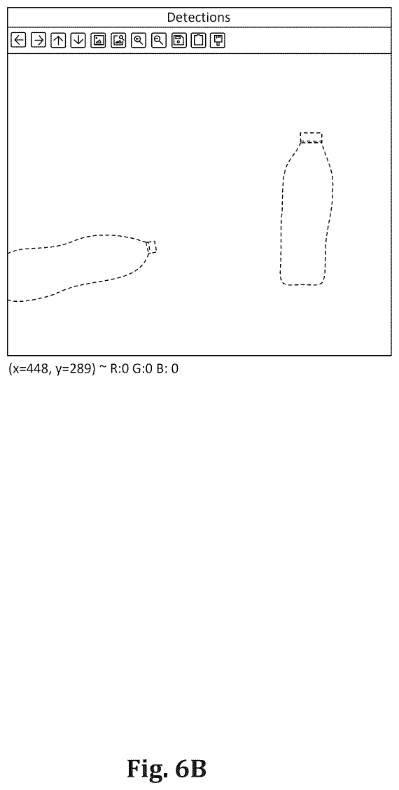

FIG. 6A illustrates a computer vision output (Raw RGB) associated with the one or more UAVs 208 detecting one or more objects, in accordance with some embodiments.

FIG. 6B illustrates a computer vision output (detection) associated with the one or more UAVs 208 detecting one or more objects, in accordance with some embodiments.

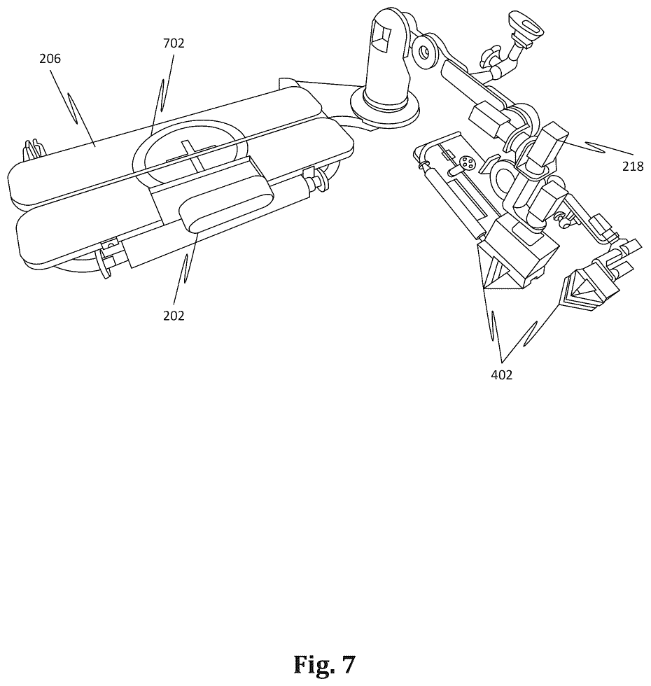

FIG. 7 illustrates a docking site associated with the one or more UAVs 208 on the one or more trays 206, in accordance with some embodiments.

Further, the docking site may include the alignment guide 702 integrated to the one or more trays 206.

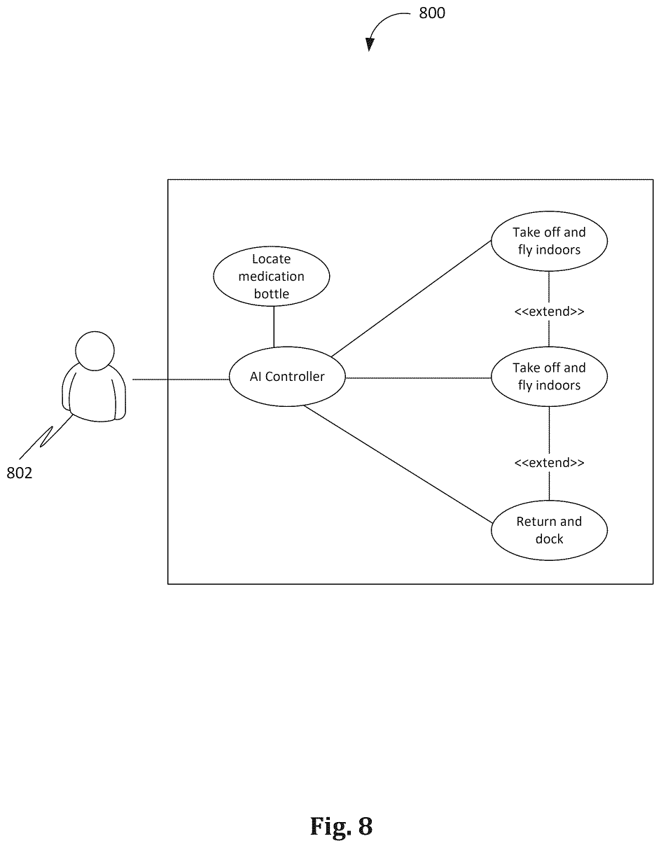

FIG. 8 illustrates a use case scenario 800 associated with the one or more UAVs 208, in accordance with some embodiments.

Further, the one or more UAVs 208 may include a plurality of cameras, an IMU, a SLAM module, an AI object detection, and a computer vision controller. Further, once the one or more UAVs 208 take off for searching one or more items indoors, the one or more UAVs 208 also track the motion of the robolator and its docking site on the one or more trays 206. Further, when the one or more UAVs 208 finish the flying task, the one or more UAVs 208 automatically land on the tray. Further, the user interaction with the one or more UAVs 208 may be via one or more of a voice command, a smartphone app, and the joystick controller 332.

Further, an example of the use case scenario associated with the one or more UAVs 208 may include one or more of locating a medication bottle and checking if a stove is on. Further, the user 802 may include an elderly individual seated in a living room. Further, the drone with vision-enabled autonomous assistant docked on the robolator's food tray. Further, the robolator has an AI Controller, which may act as an embedded system managing one or more of a mission planning and a sensor fusion. Further, the one or more UAVs may have one or more of a thermal camera and a gas sensor for stove checking.

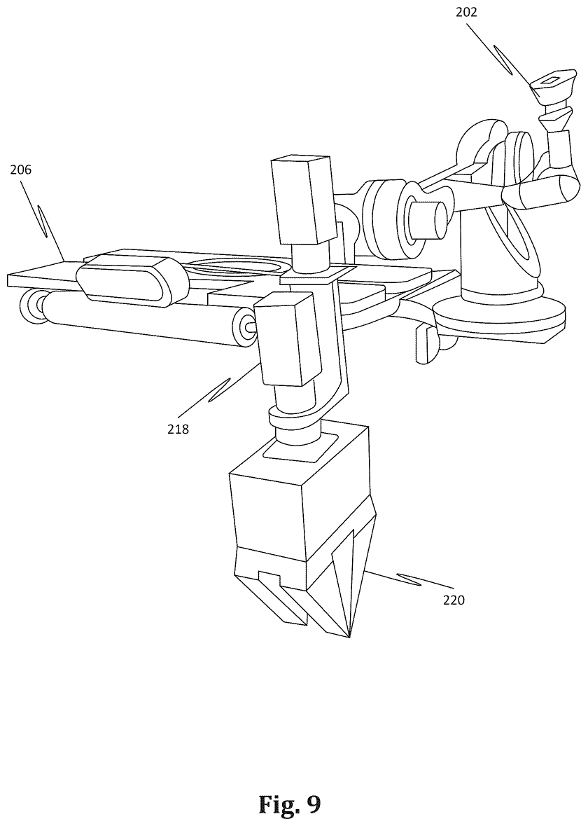

FIG. 9 illustrates a perspective view of the one or more bionic arms 218, in accordance with some embodiments.

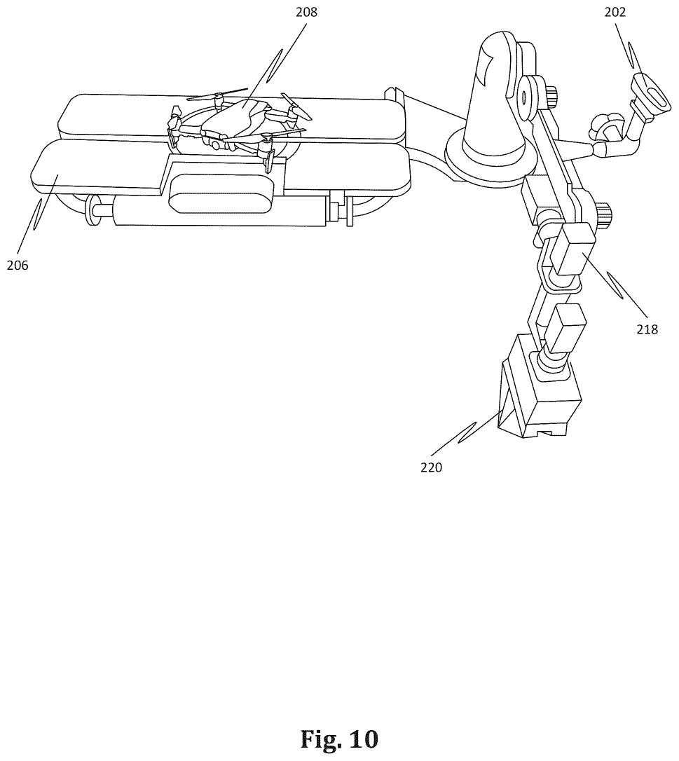

FIG. 10 illustrates a perspective view of the one or more bionic arms 218 including the one or more UAVs 208, docked on the one or more trays 206, in accordance with some embodiments.

Further, the one or more bionic arms 218 may be designed to be very light and flexible. Further, the unique structural design and arrangement of the one or more bionic arms 218 separate the load-bearing capability from the motor actuation. So the one or more bionic arms 218 may passively carry a rather big and heavier weight. For example, to allow a person to put his/her arm on it. Further, the one or more bionic arms 218 may also withstand a bump. Further, the one or more bionic arms 218 may also be designed for durability and impact resistance. The functional capabilities of the one or more bionic arms 218 with an AI algorithm include pick and place tasks, such as picking a cup of coffee and placing the cup on the one or more trays 206. Further, the one or more bionic arms 218 may also perform a touch and open operation. Further, the one or more bionic arms 218 may touch to open one or more of a microwave oven's door and a refrigerator's door.

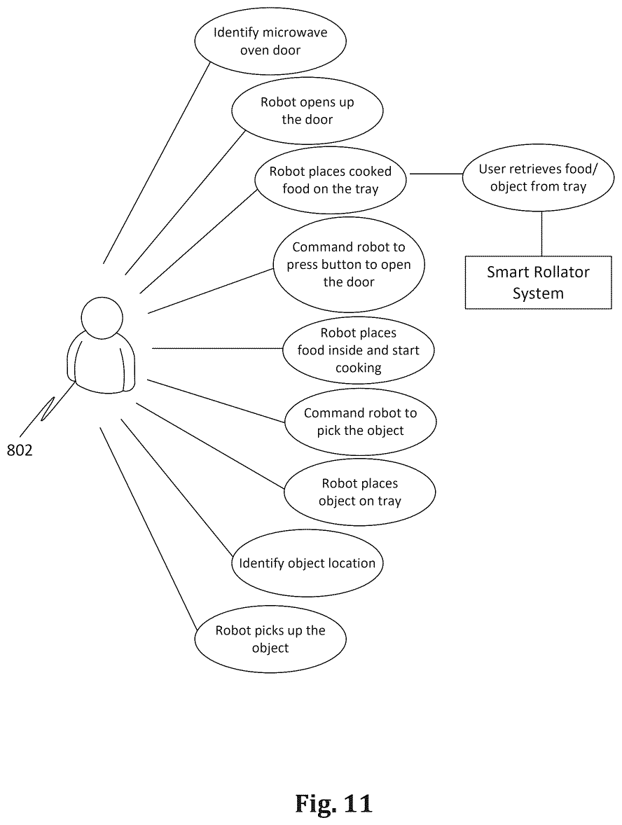

FIG. 11 illustrates one or more operations associated with the one or more bionic arms 218, in accordance with some embodiments.

Further, the one or more bionic arms 218 may be equipped with a color camera and the computer vision algorithm. Further, the one or more bionic arms 218 may be capable of performing various tasks, such as “pick and place” and “touch and open” based on object recognition. Example use may include finding one or more of a water bottle and a smartphone, and then picking the water bottle and placing the water bottle on the one or more trays 206.

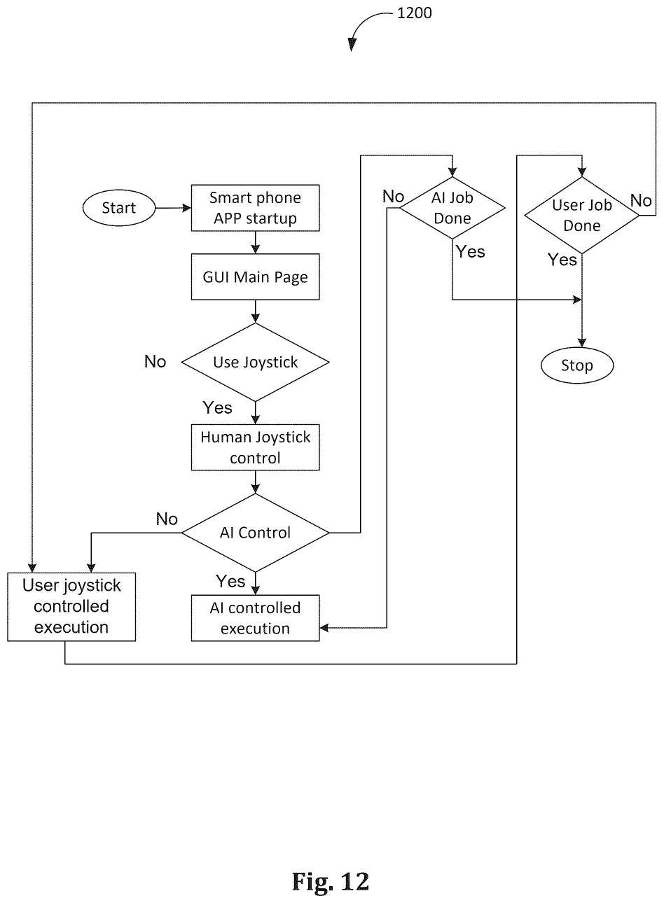

FIG. 12 illustrates a flowchart of a process 1200 associated with a user interface for one or more of a manual mode and an AI-assisted mode of the apparatus 100, in accordance with some embodiments.

Further, the user interface may combine both a smartphone APP and the joystick control 332. Further, the smartphone app's user interface provides a GUI (graphical user interface) that provides a menu selection to operate the rollator. Further, one of the tags from the selection menu is marked as “User Control”; when the given option is selected, the user 802 may take full control of the robolator. Once the given function is selected, the user 802 may use the joystick controller 332 to control the one or more operations associated with the one or more bionic arms 218. Further, when an AI-based control is needed, the user 802 may press a touch button switch on the joystick controller 332 to hand over the control to the AI.

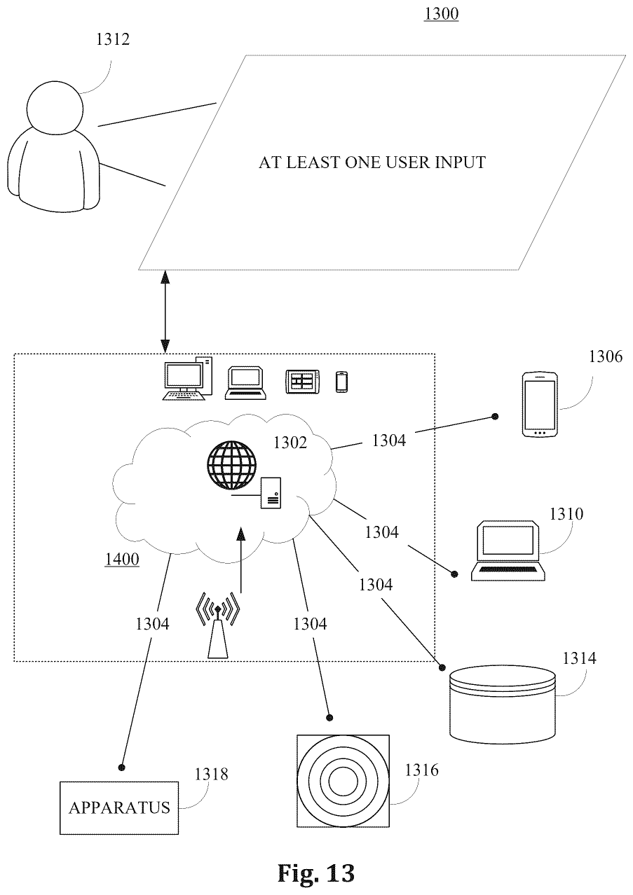

FIG. 13 is an illustration of an online platform 1300 consistent with various embodiments of the present disclosure. By way of non-limiting example, the online platform 1300 may be hosted on a centralized server 1302, such as, for example, a cloud computing service. The centralized server 1302 may communicate with other network entities, such as, for example, a mobile device 1306 (such as a smartphone, a laptop, a tablet computer etc.), other electronic devices 1310 (such as desktop computers, server computers etc.), databases 1314, sensors 1316, and an apparatus 1318 (such as the apparatus 100) over a communication network 1304, such as, but not limited to, the Internet. Further, users of the online platform 1300 may include relevant parties such as, but not limited to, end-users, administrators, service providers, service consumers and so on. Accordingly, in some instances, electronic devices operated by the one or more relevant parties may be in communication with the platform.

A user 1312, such as the one or more relevant parties, may access online platform 1300 through a web-based software application or browser. The web-based software application may be embodied as, for example, but not be limited to, a website, a web application, a desktop application, and a mobile application compatible with a computing device 1400.

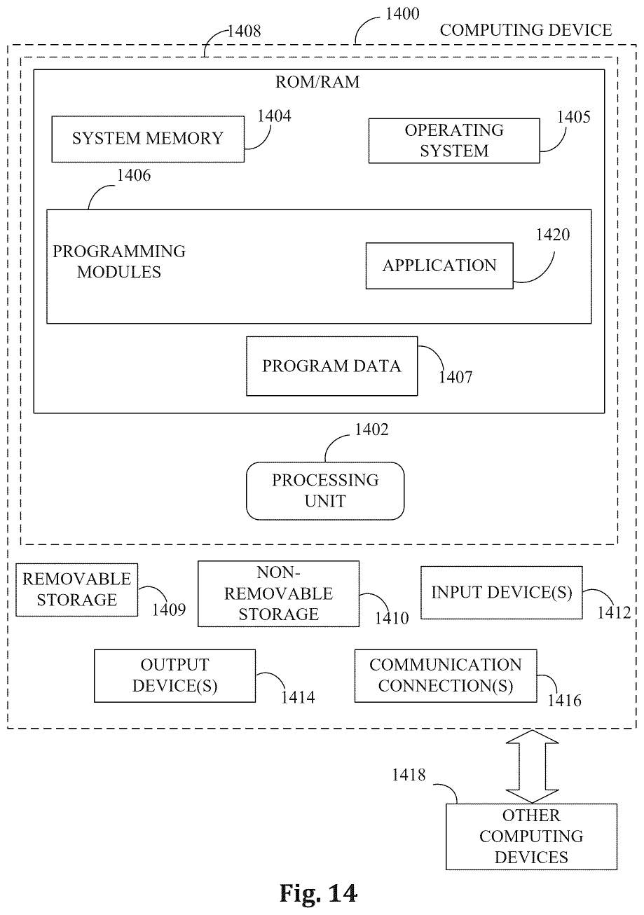

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420 such as a media player) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. An apparatus for providing assistance to users, the apparatus comprising:
a frame comprising a plurality of frame members, wherein the plurality of frame members is interconnected to define a structure;
a movement assembly coupled to the frame, wherein the movement assembly is configured for moving the apparatus for navigating the apparatus;
a processor communicatively coupled to the movement assembly, wherein the processor is configured for:
determining at least one requirement of a user associated with the apparatus; and
generating at least one command based on the at least one requirement, wherein the at least one command comprises at least one navigation command for the navigating of the apparatus and at least one operation command for performing at least one task, wherein the moving of the apparatus is based on the at least one navigation command; and
at least one peripheral device communicatively coupled with the processor, wherein the at least one peripheral device is configured for executing at least one operation for the performing of the at least one task based on the at least one operation command.

2. The apparatus of claim 1 further comprising at least one sensor communicatively coupled with the processor, wherein the at least one sensor is configured for monitoring an environment associated with the apparatus, wherein the processor is further configured for generating at least one sensor data based on the monitoring; and
analyzing the at least one sensor data, wherein the generating of the at least one command is further based on the analyzing of the at least one sensor data.

3. The apparatus of claim 1 further comprising at least one handle coupled to the frame, wherein the at least one handle is configured to be held by the user.

4. The apparatus of claim 1 further comprising at least one tray mechanically coupled with the frame, wherein the apparatus is configured to transport at least one object associated with the user using the at least one tray during the moving of the apparatus.

5. The apparatus of claim 2, wherein the at least one peripheral device comprises at least one unmanned aerial vehicle (UAV), wherein the at least one UAV is configured for executing at least one first unmanned aerial vehicle (UAV) operation, wherein the executing of the at least one operation by the at least one peripheral device comprises the executing of the at least one first UAV operation by the at least one UAV.

6. The apparatus of claim 5, wherein the at least one tray is foldable, wherein the at least one UAV is configured to land on the at least one tray and take off from the at least one tray.

7. The apparatus of claim 2, wherein the at least one peripheral device comprises at least one bionic arm operatively coupled with the frame, wherein the at least one bionic arm is configured for executing at least one assistive operation, wherein the executing of the at least one operation by the at least one peripheral device comprises the executing of the at least one assistive operation by the at least one bionic arm, wherein the at least one assistive operation comprises at least one of an object-manipulation operation and an object-retrieval operation associated with at least one external object present in the environment.

8. The apparatus of claim 1, wherein the movement assembly comprises a plurality of wheels rotatably coupled with the frame, wherein the moving of the apparatus is using the plurality of wheels, wherein the movement assembly further comprises a braking assembly operatively coupled with the plurality of wheels, wherein the braking assembly is configured for restricting the motion of the apparatus, wherein the at least one navigation command comprises at least one braking command, wherein the restricting of the motion of the apparatus is based on the at least one braking command.

9. The apparatus of claim 7, wherein the at least one sensor comprises at least one camera, wherein the monitoring of the environment comprises at least one of a capturing of at least one user within the environment and the capturing of the at least one external object present in the environment.

10. The apparatus of claim 2, wherein the at least one sensor further comprises at least one navigation sensor, wherein the at least one navigation sensor is configured for detecting at least one parameter associated with the moving of the apparatus, wherein the generating of the at least one sensor data is further based on the detecting of the at least one parameter.

11. The apparatus of claim 5 further comprising at least one input device communicatively coupled with the processor, wherein the at least one input device is configured for generating at least one user input, wherein the processor is further configured for analyzing the at least one user input, wherein the generating of the at least one command is further based on the analyzing of the at least one user input.

12. The apparatus of claim 5, wherein the at least one first UAV operation comprises at least one of a landing operation, a flight operation, and a stationing operation, wherein the executing of the at least one first UAV operation by the at least one UAV comprises at least one of the executing of the landing operation by the at least one UAV, the executing of the flight operation by the at least one UAV, and the executing of the stationing operation by the at least one UAV, wherein the at least one tray comprises at least one of an alignment guide and a charging interface, wherein the alignment guide is configured for aligning the at least one UAV on at least one position of the at least one tray during the executing of the landing operation, wherein the charging interface is configured for electrically charging the at least one UAV during the executing of the stationing operation.

13. The apparatus of claim 12, wherein the at least one UAV comprises at least one UAV camera, wherein the at least one first UAV operation further comprises a surveillance operation, wherein the executing of the at least one first UAV operation by the at least one UAV further comprises the executing of the surveillance operation by the at least one UAV using the at least one UAV camera during the executing of the flight operation.

14. The apparatus of claim 13, wherein the at least one UAV further comprises a UAV processor communicatively coupled with each of the at least one UAV camera and the processor, wherein the UAV processor is configured for generating at least one surveillance data based on the executing of the surveillance operation, wherein the processor is further configured for analyzing the at least one surveillance data, wherein the generating of the at least one command is further based on the analyzing of the at least one surveillance data.

15. The apparatus of claim 14, wherein the processor is further configured for generating at least one flight command associated with the at least one UAV based on the analyzing of the at least one surveillance data, wherein the at least one UAV is configured for executing at least one second unmanned aerial vehicle (UAV) operation, wherein the executing of the at least one operation by the at least one peripheral device further comprises the executing of at least one second UAV operation by the at least one UAV, wherein the executing of the at least one second UAV operation is based on the at least one flight command, wherein the executing of the at least one second UAV operation occurs later than the executing of the at least one first UAV operation.

16. The apparatus of claim 1 further comprising at least one battery unit electrically coupled with the movement assembly, wherein the at least one battery unit is configured for powering the movement assembly 104, wherein the moving of the apparatus is further based on the powering of the movement assembly 104.

17. The apparatus of claim 11, wherein the analyzing of the at least one user input comprises the analyzing of the at least one user input using an artificial intelligence (AI) model, wherein the determining of the at least one requirement of the user comprises the determining of the at least one requirement of the user using the AI model based on the analyzing of the at least one user input using the AI model, wherein the generating of the at least one command is further based on the determining the at least one requirement of the user using the AI model.

18. The apparatus of claim 15, wherein the processor is further configured for identifying a location of the at least one external object in the environment based on the analyzing the at least one surveillance data, wherein the generating of the at least one flight command is further based on the identifying of the location.

19. An apparatus for providing assistance to users, the apparatus comprising:
a frame comprising a plurality of frame members, wherein the plurality of frame members is interconnected to define a structure;
a movement assembly 104 coupled to the frame, wherein the movement assembly 104 is configured for moving the apparatus for navigating the apparatus;
a processor communicatively coupled to the movement assembly 104, wherein the processor is configured for:
determining at least one requirement of a user associated with the apparatus; and
generating at least one command based on the at least one requirement, wherein the at least one command comprises at least one navigation command for the navigating of the apparatus and at least one operation command for performing at least one task, wherein the moving of the apparatus is based on the at least one navigation command;
at least one peripheral device communicatively coupled with the processor, wherein the at least one peripheral device is configured for executing at least one operation for the performing of the at least one task based on the at least one operation command; and
at least one sensor communicatively coupled with the processor, wherein the at least one sensor is configured for monitoring an environment associated with the apparatus, wherein the processor is further configured for:
generating at least one sensor data based on the monitoring; and
analyzing the at least one sensor data, wherein the generating of the at least one command is further based on the analyzing of the at least one sensor data.

20. An apparatus for providing assistance to users, the apparatus comprising:
a frame comprising a plurality of frame members, wherein the plurality of frame members is interconnected to define a structure;
a movement assembly 104 coupled to the frame, wherein the movement assembly 104 is configured for moving the apparatus for navigating the apparatus;
a processor communicatively coupled to the movement assembly 104, wherein the processor is configured for:
determining at least one requirement of a user associated with the apparatus; and
generating at least one command based on the at least one requirement, wherein the at least one command comprises at least one navigation command for the navigating of the apparatus and at least one operation command for performing at least one task, wherein the moving of the apparatus is based on the at least one navigation command;
at least one peripheral device communicatively coupled with the processor, wherein the at least one peripheral device is configured for executing at least one operation for the performing of the at least one task based on the at least one operation command, wherein the at least one peripheral device comprises at least one of at least one unmanned aerial vehicle (UAV) and at least one bionic arm, wherein the at least one UAV is configured for executing at least one first unmanned aerial vehicle (UAV) operation, wherein the at least one bionic arm is configured for executing at least one assistive operation, wherein the executing of the at least one operation by the at least one peripheral device comprises at least one of the executing of the at least one UAV operation by the at least one UAV and the executing of the at least one assistive operation by the at least one bionic arm; and
at least one input device communicatively coupled with the processor, wherein the at least one input device is configured for generating at least one user input, wherein the processor is further configured for analyzing the at least one user input, wherein the generating of the at least one command is further based on the analyzing of the at least one user input.
